(19) United States
(12) Patent Application Publication
(10) Pub. No.: US 2025/0002414 A1
(43) Pub. Date: Jan. 2, 2025

(54) CEMENTITIOUS PRODUCTS INCLUDING ADMIXTURES, AND ASSOCIATED SYSTEMS AND METHODS

(71) Applicant: GRAYMONT WESTERN CANADA INC., Richmond (CA)

(72) Inventors: Nikolas Andrei Romaniuk, Edmonton (CA); Narain Hariharan, South Jordan, UT (US); Lucas McFarlane, Salt Lake City, UT (US)

(21) Appl. No.: 18/749,011

(22) Filed: Jun. 20, 2024

Related U.S. Application Data
(60) Provisional application No. 63/510,592, filed on Jun. 27, 2023.

(51) Int. Cl. C04B 28/06; C04B 14/28; C04B 24/18; C04B 28/12; C04B 40/00; C04B 103/10; C04B 103/20; C04B 103/30

(52) U.S. Cl. CPC C04B 28/065; C04B 14/28; C04B 24/18; C04B 28/12; C04B 40/0042; C04B 2103/10; C04B 2103/20; C04B 2103/302; C04B 2103/304

(57) ABSTRACT

A lime-based cement extender composition and associated systems and methods are disclosed herein. A lime-based binder or cement extender includes lime particles comprising calcium hydroxide and/or calcium oxide, pozzolan particles including silicon dioxide and/or aluminum dioxide; and an admixture. The admixture is configured to promote reactions between the lime particles and the pozzolan particles. When the composition is mixed with cement to form a cement blend, calcium aluminum sulfate forms within 28 days of blending. Additionally or alternatively, the cement blend can have a Strength Activity Index (SAI) of at least 90%.

### CROSS-REFERENCE TO RELATED APPLICATIONS

The present application claims the benefit of U.S. Provisional Patent Application No. 63/510,592, filed Jun. 27, 2023, the disclosure of which is incorporated herein by reference in its entirety. The present application is related to (i) U.S. patent application Ser. No. 18/087,728, filed Dec. 22, 2022, titled LIME-BASED CEMENT EXTENDER COMPOSITIONS, AND ASSOCIATED SYSTEMS AND METHODS, and (ii) U.S. patent application Ser. No. 18/390,399, filed Dec. 20, 2023, titled SYSTEMS AND METHODS FOR STORING AND MINERALIZING CARBON DIOXIDE WITH LIME, the disclosures of which are incorporated herein by reference in their entireties.

### TECHNICAL FIELD

This present technology relates to lime-based binders, compositions, and/or cementitious products including admixtures, and associated systems and methods. Particular embodiments of the present technology relate to combining a lime-based composition, cement, and admixtures to produce products for use in the mining, cement, construction, and other industries.

### BACKGROUND

Conventional mine backfill solutions generally include a combination of cement and fly ash, which is used as a cement extender or supplementary cementitious material. However, using fly ash for mine backfill has certain disadvantages, including that significant amounts of fly ash are needed and that the unconfined compressive strength (UCS) of fly ash varies, e.g., depending on the quality of the fly ash. Additionally, the availability of fly ash is diminishing over time, in part because fly ash is produced as a by-product at coal facilities which are being decommissioned or turned down due to issues associated with the environment and greenhouse gas emissions. The diminishing supply of fly ash has caused its cost (e.g., relative to the cost of cement) to increase, making the economics for producing mine backfill with fly ash unpredictable and less desirable. As such, a need exists to develop alternatives to fly ash and/or improve mine backfill solutions.

### BRIEF DESCRIPTION OF THE DRAWINGS

Features, aspects, and advantages of the presently disclosed technology may be better understood with regard to the following drawings.

FIG. 1 is a schematic block diagram of a system for manufacturing lime-based compositions, in accordance with embodiments of the present technology.

FIG. 2 is a flow diagram of a method for producing lime-based compositions, in accordance with embodiments of the present technology.

FIG. 3A illustrates the relationship between UCS and varying amounts of quicklime, in accordance with embodiments of the present technology.

FIG. 3B illustrates the relationship between UCS and varying amounts of limestone, in accordance with embodiments of the present technology.

FIG. 3C illustrates the relationship between UCS and varying amounts of pozzolan, in accordance with embodiments of the present technology.

FIG. 4A illustrates the UCS of various concrete cylinders without admixtures over time, in accordance with embodiments of the present technology.

FIG. 4B illustrates the UCS of various concrete cylinders with admixtures over time, in accordance with embodiments of the present technology.

FIGS. 4C-4E illustrate the Strength Activity Index (SAI) of various types of concrete cylinder over time, in accordance with embodiments of the present technology.

FIG. 5 illustrates how concrete wet densities of various types of cement blend pastes vary with different water-to-cement blend ratios, in accordance with embodiments of the present technology.

A person skilled in the relevant art will understand that the features shown in the drawings are for purposes of illustration, and variations, including different and/or additional features and arrangements thereof, are possible.

### DETAILED DESCRIPTION

### I. Overview

Embodiments of the present technology relate to combining lime, calcium carbonate, pozzolans, and/or an admixture to produce a lime-based binder or cement extender composition. The binder can be combined (e.g., mixed) with cement to form a cement blend. Water can be added to the cement blend to form a cement blend paste. The cement blend paste can be combined (e.g., mixed) with aggregates (e.g., sand, stone, gravel, etc.) to form a product mixture. In some embodiments, such product mixtures can be used in the mining or other industries (e.g., as mine backfill) or act as a replacement (or partial replacement) for cement in concrete and soil treatment applications. As noted above, mine backfill solutions can generally include a combination of cement and fly ash, which is used as a cement extender or supplementary cementitious material. However, because the availability of fly ash is diminishing over time, significant amounts of fly ash are needed, and the unconfined compressive strength (UCS) of fly ash varies depending on the quality of the fly ash, using fly ash can cause difficulties.

Embodiments of the present technology address at least some of the above-described issues associated with using fly ash in combination with cement, e.g., for mine backfill applications, by producing a lime-based cement extender composition (also referred to as supplementary cementitious material or composition, or lime-based binder) that can effectively act as a substitute or alternative for fly ash when combined with cement. Additionally, embodiments of the present technology can also be used to replace or partially replace cement in concrete and soil treatment applications, e.g., for the construction industry. For example, as described elsewhere herein, embodiments of the present technology can comprise a lime-based binder or cement extender composition including lime particles (e.g., calcium hydroxide and/or calcium oxide), pozzolan particles (e.g., active silica, active alumina, silicon oxide, and/or aluminum dioxide), and one or more admixtures. In some embodiments, the lime-based binder or cement extender composition can further include calcium carbonate particles (e.g., limestone, pulverized calcium carbonate (PCC), manufactured calcium carbonate). Additionally or alternatively, at least 90% of the lime particles, calcium carbonate particles, and/or pozzolan particles have a particle size less than a predetermined size (e.g., 75 microns). The admixtures can include an accelerant, a retardant, a water reducer, an activator, an air entrainer, a superplasticizer and/or a synthetic polymer. The admixture can be configured to promote reactions between the lime particles and the pozzolan particles, for example, to speed up the hardening of the cement, increase workability of the cement, and/or modify other properties of the cement. The admixture can be configured to promote reactions between the calcium oxide and at least one of the aluminum oxide or silicon dioxide (or other component) present in the pozzolan. In some embodiments, the composition comprises no more than 10%, 8%, 6%, 4%, or 2% of the admixture.

Additionally or alternatively, the lime-based cement extender composition can comprise a calcium oxide concentration of 25-65%, a magnesium oxide concentration of 0.5-2%, an iron oxide concentration of 0.5-2.0%, an aluminum oxide concentration of 2-8%, a silicon dioxide concentration of 20-50%, a potassium oxide concentration of 20,000-45,000 ppm, and a sodium oxide concentration of 10,000-30,000 ppm. Such concentrations can be determined based on an elemental analysis (e.g., in which an element of this composition is vaporized (e.g., via inductively coupled plasma (ICP)) and then analyzed by spectrometry (e.g., atomic emission spectroscopy (AES) or mass spectrometry)). For example, the percent calcium oxide may be determined based on the elemental amount of calcium, the percent magnesium oxide may be determined based on the elemental amount of magnesium, and the percent iron oxide may be determined based on the elemental amount of iron. In some embodiments, the lime-based cement extender composition, or product, can be combined with cement to produce a cement blend for use in the mining industry as mine backfill.

Embodiments of the present technology enable the production of improved lime-based compositions, e.g., for mine backfill applications, that do not include or rely on fly ash or slag (e.g. ground granulated blast furnace slag). As such, embodiments of the present technology may not be affected by the diminishing supply and increased price of fly ash or slag. Additionally, embodiments of the present technology, when combined with cement, can form an improved product (e.g., mine backfill product) that uses relatively less material, has less variability in composition, lasts longer, and has a higher unconfined compressive strength relative to products that use fly ash or slag. Additionally, the greenhouse gas and carbon footprint associated with producing embodiments of the present technology can be less than that of using cement alone or producing fly ash or slag, which are produced as a by-product of coal facilities or blast furnaces, respectively.

In this regard, cement production can also have a large greenhouse gas and carbon footprint. Cement includes tricalcium silicates phases (commonly referred to as the ‘alite’ phase in traditional cement clinker production) that are responsible for higher and faster rates of strength gain in the end product (e.g., mine backfill product). The production of alite phases, or more specifically the energy associated with calcining raw materials (e.g. Scope 2 emissions) and the process emissions (e.g. Scope 1 emissions) to produce cement clinker (an intermediary product in the manufacture of Portland cement) is largely responsible for the greenhouse gas footprint associated with cement.

Embodiments of the present technology can enable the production of improved lime-based compositions that have a lower greenhouse gas and carbon footprint, e.g., by replacing in whole or in part the effect of alites in traditional cement with admixtures, while also having sufficient strength (e.g., unconfined compressive strength). The admixtures of the present technology can be introduced act as a catalyst to influence the sequence and accelerate the kinetics of pozzolanic reactions between the pozzolan, lime and calcium carbonate, and thereby enable the formation of phase calcium silicate hydrates and calcium aluminate hydrates at accelerated rates yielding faster rate of strength gain in the end product (e.g. mine backfill product) that is comparable hydraulic cements phases (e.g. Alite). In doing so, the greenhouse gas footprint associated with production of pozzolanic cements with strength gains comparable to ‘alite’ phases using the present technology that utilizes admixtures are significantly lower (e.g., at least 10%, 20%, or 30% lower) compared to traditional clinker production, e.g., due to the avoidance of energy associated with the calcination of raw materials to produce clinker. As such, embodiments of the present technology enable production of compositions that have equivalent or improved strength to traditional cement products, while also having a lower greenhouse gas and carbon footprint.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Lime-Based Cement Extender Compositions and Associated Systems and Methods

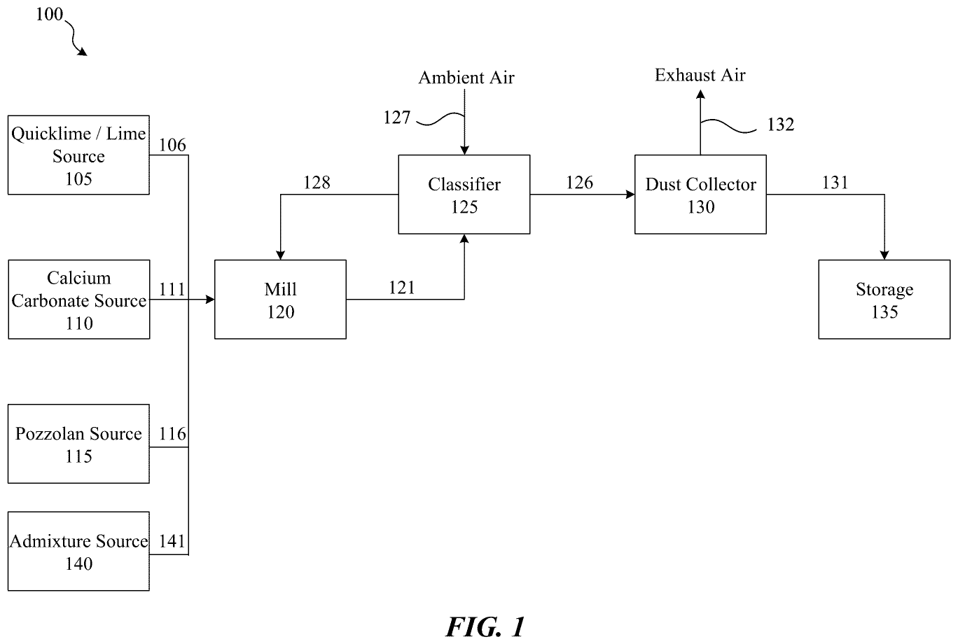

FIG. 1 is a schematic block diagram of a system 100 for manufacturing lime-based compositions, in accordance with embodiments of the present technology. The system 100 can include a quicklime and/or lime source 105 (“lime source 105”), a calcium carbonate source 110, a pozzolan source 115, and an admixture source 140. The lime source 105 can comprise quicklime (i.e., calcium oxide), dolomitic quicklime, lime (i.e., calcium hydroxide), hydrated lime, and/or enhanced lime (e.g., lime having a specific surface area greater than 35 m²/g) and can have a particle size less than 75 microns, 70 microns, 60 microns, or 50 microns. For example, at least 90%, 93%, 95%, 98%, or 99% of the lime particles have a particle size less than 75 microns. The lime can have a calcium content of at least 80%, 85%, 86%, 87%, 88%, 89%, 90%, 91%, 92%, 93%, 94%, or 95% by weight. The lime source 105 can provide available calcium and/or calcium hydroxide at a high pH (e.g., above 11.5 or 12.0) to the downstream mixture, which in part enables pozzolanic reactions to occur and strength to be gained for the downstream mixture and/or end product. In some embodiments, the calcium carbonate source 110 and/or the pozzolan source 115 can each contain up to 8% water.

The calcium carbonate source 110 can comprise calcium carbonate particles including high-calcium limestone, PCC, manufactured calcium carbonate, argillaceous limestone, and/or dolomitic lime. The calcium carbonate particles can have a particle size less than 75 microns, 70 microns, 60 microns, or 50 microns. For example, at least 90%, 93%, 95%, 98%, or 99% of the calcium carbonate particles have a particle size less than 75 microns. The calcium carbonate can have a calcium concentration of at least 80%, 85%, 86%, 87%, 88%, 89%, 90%, 91%, 92%, 93%, 94%, or 95% by weight. The calcium carbonate source 110 can enable the downstream mixture to have increased strength and, without being bound by theory, can provide nucleation sites for cementation reactions and provide fine filler materials that increase strengths by optimizing the particle size distribution of the backfill mixtures. In some embodiments, the calcium carbonate source 110 can be omitted from the system 100.

The pozzolan source 115 can comprise a natural pozzolan, volcanic ash, zeolite, calcined clay, silicate, aluminate, silica flume, bauxite residue, pozzolan slag, volcanic ash and/or zeolite. In some embodiments, the pozzolan source 115 can comprise (i) at least 5%, 6%, 7%, 8%, 9%, or 10% by weight aluminum oxide, (ii) at least 50%, 55%, 60%, 61%, 62%, 63%, 64%, or 65% by weight silicon dioxide, (iii) at least 50,000 ppm, 52,000 ppm, 54,000 ppm, or 56,000 ppm potassium oxide, and (iv) at least 30,000 ppm, 32,000 ppm, 34,000 ppm, or 36,000 ppm sodium oxide, e.g., as determined by elemental analysis from ICP methods. The pozzolan particles can have a particle size less than 75 microns, 70 microns, 60 microns, or 50 microns. For example, at least 90%, 93%, 95%, 98%, or 99% of the pozzolan particles have a particle size less than 75 microns, 70 microns, or 65 microns. The pozzolan source 115 acts as the silicate and aluminate source for the downstream mixture and/or end product, and in part enables the downstream mixture and/or end product to build strength via pozzolanic reactions.

The admixture source 140 can comprise an admixture in a form of a fluid or a solid material (e.g., a powder). The admixture can comprise one or more of an accelerant, a retardant, a water reducer, an activator, a superplasticizer, an air-entrainer, and/or a synthetic polymer. The admixtures can be in compliance with the Standard Specification for Chemical Admixtures for Concrete under ASTM C494/C494M. An accelerant can be configured to shorten the setting time of a cement blend, thereby reducing cure time of the cement and allowing the mixture to meet strength targets early. Moreover, an accelerant can enable setting and curing of cement at low temperatures (e.g., during winter weather). An accelerant can include calcium chloride, triethanolamine, sodium thiocyanate, calcium formate, calcium nitrite, and/or calcium nitrate.

A retardant can be configured to lengthen the setting time of a cement blend, thereby increasing cure time of the cement and allowing the mixture to remain flowable and/or workable for a longer period of time. A retardant can include calcium salts, magnesium salts, sodium salts, ammonium salts, oxides of lead and zinc, phosphates, fluorates, borates, and certain carbohydrates. For admixtures including a retardant, flowability can be critical because, e.g., the mine backfill site can be located far away (e.g., greater than 3 kilometers from the blending site or place where the cement blend is formed). As such, the retardant needs to have a minimum flowability to ensure the cement blend can be pumped to the mine site. Embodiments of the present technology can include flowability (measured as yield stress) of a maximum or no more than 200 pascals, 250 pascals, 300 pascals, 350 pascals, 400 pascals, 500 pascals, 750 pascals, or 1000 pascals. Embodiments of the present technology can include workability where the material can be jammed into mine stopes and maintain cohesion up to 1 hours, 2 hours, 3 hours, or 4 hours after production.

A water reducer can include a superplasticizer and/or synthetic polymer (e.g., synthetic sulfonate or polycarboxylate). The water reducer can be configured to reduce water content in the cement (e.g., reduce the water-to-cement ratio), decrease porosity thereby increasing strength and reducing water permeability of the end product, increase workability and slump, lower cement content, and/or improve durability by reducing the diffusivity of aggressive agents in the end product. The water reducer can provide the required slump with less water in the mix and may provide higher strength concrete without increasing the amount of cement. Dosing of water reducers can range between 0.2-2.0%, 0.2-0.8%, or other percentage ranges by weight of cement.

A water reducer may be categorized into low-range, mid-range, and high-range water reducers. A low-range water reducer can achieve at least 5% or 5-10% in water reduction, where water reduction is the reduction in the amount of mixing water, and/or 1-2 inches of slump increase. A low-range water reducer can allow mixtures to have comparable flow properties at lower water-to-binder ratios, and can include lignosulphonates, carbohydrates, and/or hydrocarboxylic acids. A mid-range water reducer can achieve 8-18%, 8-15%, etc. in water reduction and/or 4-5 inches in slump increase. A mid-range water reducer can allow mixtures to have comparable flow properties at lower water-to-binder ratios, and can include, e.g., lignosulphonates. A mid-range water reducer can also delay the initial set time of concrete and keep the concrete workable during placement. A high-range water reducer can achieve at least 12%, 14%, 16%, or 18% in water reduction and/or at least 6, 8, or 10 inches in slump increase. A high-range water reducer can allow mixtures to have comparable flow properties at significantly lower water-to-binder ratios, and can include polycarboxylates, sulfonated melamines, vinyl copolymers, and/or lignosulphonates.

An air-entraining admixture can be configured to facilitate the development of microscopic air bubbles in the mixture. An air-entraining admixture can provide increased freeze-thaw durability, increased resistance to scaling from deicing chemicals, improved workability, improved durability, and/or improved resistance to wetting/drying cycles. Dosage of air-entraining admixtures can range between 4-10%, 5-8%, or other percentage ranges by volume of concrete. An air-entraining admixture can include, e.g., fatty acid salts, abietic and pimelic acid salts, alkyl acryl sulphonates, alkyl sulphonates, phenol ethoxylates, rosin resins, aliphatic alcohol sulfonates, protein salts, and petroleum sulfonates. The air-entraining admixture can be in compliance with the Standard Specification for Air-Entraining Admixtures for Concrete under ASTM C260.

Admixtures can also comprise a combination of two or more of the above-listed types. For example, a water-reducing and retarding admixture can exhibit the properties and benefits of both water reducers and retardants, and can include lignosulphonate acids and hydroxylated carboxylic acids or a combination of a typical water-reducing and a retarding admixture. As another example, a water-reducing and accelerating admixture can exhibit the properties and benefits of both water reducers and accelerants, and can include a combination of a typical water-reducing and an accelerating admixture. As yet another example, a high-range water-reducing and retarding admixture can exhibit the properties and benefits of both high-range water reducers and retardants, and can include sulfonated napthelenes and lignosulphonates or a combination of a typical high-range water-reducing and retarding admixtures.

In some embodiments, the admixtures can also affect the workability of the composition or eventual cement blend. The workability, also referred to as the materials' tendency for cohesion, agglomeration, or aggregation, refers to the materials' ability to be clumped in a ball and stick together. The workability can be important for transporting the materials, the material properties (e.g., strength) of the resulting cement blend, etc.

The system 100 can include a plurality of weighing devices configured to weigh each of the lime source 105, calcium carbonate source 110, pozzolan source 115, and admixture source 140 (“feed components”), and a plurality of respective conveyor belts 106, 111, 116, and 141 configured to convey the feed components to a milling (e.g., co-grinding) and/or blending unit 120 (“mill 120”). The mill 120 can be a ball mill (e.g., a horizontal ball mill) configured to mechanically grind and blend the feed components to produce a milled blend provided to a classifier 125 via an inlet 121. Mechanically grinding the feed components via the mill 120 can cause the feed components to be simultaneously hydrated and dried. For example, the residual moisture of the feed components (e.g., the calcium carbonate and/or pozzolan) can chemically convert the quicklime to calcium hydroxide via Reaction 1.

CaO+H₂O→Ca(OH)₂+Heat (Reaction 1)

The heat produced via Reaction 1, and in some embodiments the heat of friction from the mechanical grinding action of the ball mill, reduces the residual moisture of the feed components. For example, the moisture content of the milled blend exiting the mill 120 can be less than 8%, 7%, 6%, 5%, 4%, 3%, or 2% by weight. As such, the system 100 is able to reduce the moisture content of the feed components with just the mill 120, and without additional equipment (e.g., a rotary dryer, burners, etc.) that increase capital and operating costs and generate combustion and other greenhouse gases that complicate environmental permitting. Doing so improves the economics of producing lime-based cement extender compositions.

The milled blend can comprise (i) at least 10%, 15%, 20%, 25%, 30%, or 10-30% by weight quicklime, (ii) 20%, 25%, 30%, 35%, 40%, 45%, 50%, or 25-50% by weight calcium carbonate, (iii) 35%, 40%, 45%, 50%, 60%, 65%, 70% or 35-70% by weight pozzolans, and (iv) no more than 10%, 8%, 6%, 4%, or 2% of an admixture. For example, the composition includes at least 10% by weight of lime particles, at least 20% by weight of calcium carbonate particles, at least 35% by weight of pozzolan particles, and no more than 10% by weight of the admixture. In another example, the composition includes 10-20% by weight of the lime particles, 40-50% by weight of the calcium carbonate particles, 35-50% by weight of the pozzolan particles, and no more than 4% by weight of the admixture. Additionally or alternatively, the milled blend can comprise (i) a calcium oxide concentration of 25-65%, (ii) a magnesium oxide concentration of 0.5-2%, (iii) an iron oxide concentration of 0.5-2.0%, (iv) an aluminum oxide concentration of 2-8%, (v) a silicon dioxide concentration of 20-50%, (vi) a potassium oxide concentration of 20,000-45,000 ppm, and (vii) a sodium oxide concentration of 10,000-25,000 ppm, e.g., as determined by elemental analysis from ICP methods. In another example, the composition includes 10-35% by weight of lime particles, 5-10% by weight of calcium carbonate particles, 55-85% by weight of pozzolan particles, and no more than 10% by weight of the admixture. In another example, the composition includes 10-20% by weight of the lime particles, 40-50% by weight of the calcium carbonate particles, 35-50% by weight of the pozzolan particles, and no more than 4% by weight of the admixture.

The amount of calcium oxide or calcium hydroxide of the milled blend that is available to react as part of the pozzolan reactions can be at least 10% by weight, no more than 30% by weight, or 10-30% by weight. The amount of available calcium oxide or calcium hydroxide can be determined based on ASTM C 25-19: “Standard Test Methods for Chemical Analysis of limestone, quicklime, and hydrated lime.”

The system 100 can further comprise an air separation and classification unit 125 (“classifier 125”) configured to receive an ambient air stream 127 and produce a binder or cement extender composition (e.g., binder for producing a mine backfill product) via an outlet 126. The classifier 125 can comprise an inlet 121, an outlet 126, and a return line 128 extending from the classifier 125 to the mill 120. The inlet 121 of the classifier 125 can comprise or be coupled to one or more screw conveyors and bucket elevators configured to transfer the milled blend from the mill 120 to the classifier 125. The classifier 125 can include a mechanical air-swept separator sized such that at least 90%, 95%, or 99% of the particles are configured to pass 200 mesh and/or have a particle size no more than 75 microns. Such a particle size, relative to large particles, increases the surface area to volume ratio and enables the binder to react quickly (or relatively quicker). Additionally, by reducing the particle size to pass 200 mesh and/or be no more than 75 microns, the particle size distribution is more uniform, thereby inhibiting the likelihood of segregation during transport, and the particle size is more similar to that of cement, thereby enabling better mixing and inhibiting segregation. Particles that do not pass through the separator will impact a rotating mechanical member of the separator and be returned to the mill 120, e.g., via the return line 128 (e.g., a chute) or other means, for further milling and size reduction. After further milling, these particles can be redirected to the classifier 125 via the one or more screw conveyors and bucket elevators and/or inlet 121.

The system 100 can further comprise a dust collector 130 (e.g., a baghouse) downstream of the classifier 125 and storage 135 downstream of the dust collector 130. The particles that have a suitable particle size and pass through the separator of the classifier 125 are directed to the dust collector 130. The dust collector 130 emits an exhaust air stream 132 and is configured to remove dust and other fines prior to the binder being directed, e.g., via conveyors and/or elevators 131 to the storage 135 (e.g., product silos) for distribution to customers.

The binder or cement extender composition (e.g., binder for producing mine backfill product) sent to the storage 135 can comprise particles for which at least 90%, 95%, or 99% passes 200 mesh and/or has a particle size no more than 75 microns. Additionally, the product can have a composition similar or identical to that of the mill 120. For example, the binder can comprise (i) at least 10%, 15%, 20%, 25%, 30%, or 10-30% by weight quicklime, (ii) 20%, 25%, 30%, 35%, 40%, 45%, 50%, or 25-50% by weight calcium carbonate, and (iii) 35%, 40%, 45%, 50%, 60%, 65%, 70% or 35-70% by weight pozzolans, and no more than 10%, 8%, 6%, 4%, or 2% of the admixture. Additionally or alternatively, the binder can comprise (i) a calcium oxide concentration of 45-65%, (ii) a magnesium oxide concentration of 0.5-2%, (iii) an iron oxide concentration of 0.5-2%, (iv) an aluminum oxide concentration of 2-8%, (v) a silicon dioxide concentration of 20-40%, (vi) a potassium oxide concentration of 20,000-30,000 ppm, and (vii) a sodium oxide concentration of 10,000-20,000 ppm, e.g., as determined by elemental analysis from ICP methods.

In some implementations, the binder (e.g., the lime-based cement extender composition) comprises 10-33.4% of the calcium oxide, 33.4-50% of at least one of the aluminum oxide or silicon dioxide, and at least 1% admixture. Additionally, the lime-based cement extender can further include 10-33.4% of the calcium oxide, 33.4-50% of the calcium carbonate, 33.4-50% of at least one of the aluminum oxide or silicon dioxide, and at least 1% of the admixture.

The binder (e.g., the lime-based composition) can have a UCS equal to or greater than 0.70 Megapascals (MPa) (e.g., at least 28 days after formation) that increases over time. A relatively high UCS is a desirable characteristic for product mixtures used in the mining industry, e.g., as mine backfill. As shown in the UCS data in Table 1 below, which uses a 7% by weight TBC of the model backfill system (e.g., including water, TBC, and untreated backfill), the UCS measured at Day 28 for each of the samples shown that includes calcium carbonate is greater than 0.70 MPa, and the greatest UCS obtained is for binders comprising at least 21.25% calcium carbonate and 21.25% natural pozzolan.

TABLE 1

| Total Binder Composition (TBC) | | | | | | | |
|---|---|---|---|---|---|---|---|
| Portland | | | Natural | 20 Hour UCS | | 28 Day UCS | |
| Cement | Quicklime | Limestone | Pozzolan | MPa | | MPa | |
| 100.00% | 0.00% | 0.00% | 0.00% | 0.20 | ±0.02 | 0.90 | ±0.01 |
| 50.00% | 50.00% | 0.00% | 0.00% | 0.12 | ±0.02 | 0.62 | ±0.07 |
| 50.00% | 10.00% | 20.00% | 20.00% | 0.10 | ±0.01 | 0.70 | ±0.10 |
| 75.00% | 10.00% | 20.00% | 20.00% | 0.10 | ±0.02 | 0.73 | ±0.02 |
| 50.00% | 7.50% | 21.25% | 21.25% | 0.10 | ±0.02 | 0.88 | ±0.05 |
| 50.00% | 5.00% | 22.50% | 22.50% | 0.17 | ±0.02 | 0.94 | ±0.02 |

In some embodiments, the binder can be combined with cement to produce a cement blend (and/or further combined with water to produce a cement blend paste, and/or even further combined with aggregates to produce a product mixture) for use in the mining industry, e.g., as mine backfill. In such embodiments, the binder can comprise at least 20%, 25%, 30%, 35%, 40%, 45%, 50%, or 55% of the cement blend, with cement comprising the balance. For example, the binder can comprise 45-55% of the cement blend. As shown in Table 2 below, the cement blend can have a UCS that increases over time (e.g., from Days 7 to 28) in a model sand system with 20% binder content. For example, the unconfined compressive strength of the binder seven days after being formed is at least 8 MPa, 9 MPa, 10 MPa, 11 MPa, 12 MPa, or 13 MPa, and the unconfined compressive strength of the binder 28 days after being formed is at least 11 MPa, 12 MPa, 13 MPa, 14 MPa, 15 MPa, 16 MPa, or 17 MPa. The UCS measurements shown in Table 2 were determined based in part on ASTM C109 “Standard Test Method for Compressive Strength of Hydraulic Cement Mortars” using 2-inch (or 50 mm) cube specimens. Additionally, the TBC by weight of the mortar mix (e.g., including water, TBC, and sand) is 20%.

As also shown in Table 2, the cement blend can over time have a higher UCS relative to cement alone. That is, for nearly every “Binder Composition” (e.g., the lime-based cement extender composition) of Table 2 comprising 50% by weight each of Portland Cement and the binder (i.e., a combination of quicklime, limestone, and pozzolan), the UCS of the Binder Composition at Day 28 was higher than that of Portland Cement on its own.

TABLE 2

| | | | | | | | | Relative | |
|---|---|---|---|---|---|---|---|---|---|
| | | | | Unconfined Compressive | | | | performance | |
| | | | | Strength | | | | indexed to | |
| Total Binder Composition (TBC) | | | | Day 7 | | Day 28 | | Portland Cement | |
| Portland | | | | | St. | | St. | Only | |
| Cement | Quicklime | Limestone | Pozzolan | MPa | dev | MPa | dev | Day 7 | Day 28 |
| 50% | 0.0% | 25.0% | 25.0% | 10.3 | 1.8 | 12.8 | 3.0 | 0.78 | 1.01 |
| 50% | 16.7% | 16.7% | 16.7% | 9.8 | 0.3 | 13.6 | 0.7 | 0.74 | 1.07 |
| 50% | 10.0% | 20.0% | 20.0% | 10.8 | 0.5 | 14.7 | 1.4 | 0.81 | 1.16 |
| 50% | 5.0% | 25.0% | 20.0% | 8.6 | 1.0 | 14.6 | 2.2 | 0.65 | 1.15 |
| 50% | 5.0% | 20.0% | 25.0% | 9.1 | 1.5 | 17.1 | 2.2 | 0.68 | 1.35 |
| 50% | 5.0% | 22.5% | 22.5% | 10.8 | 0.5 | 11.8 | 1.1 | 0.82 | 0.93 |
| 50% | 7.5% | 21.3% | 21.3% | 10.7 | 0.6 | 15.2 | 1.2 | 0.80 | 1.20 |
| 50% | 12.5% | 18.8% | 18.8% | 10.5 | 0.3 | 16.7 | 1.0 | 0.79 | 1.31 |
| 50% | 10.0% | 20.0% | 20.0% | 9.8 | 1.7 | 15.7 | 1.9 | 0.74 | 1.24 |
| 50% | 5.0% | 22.5% | 22.5% | 8.7 | 0.4 | 15.5 | 0.7 | 0.65 | 1.22 |
| 50% | 7.5% | 21.3% | 21.3% | 10.3 | 0.4 | 15.0 | 1.7 | 0.77 | 1.18 |
| 50% | 7.5% | 22.5% | 20.0% | 8.5 | 0.8 | 13.7 | 1.3 | 0.64 | 1.08 |
| 50% | 7.5% | 20.0% | 22.5% | 11.3 | 0.3 | 17.7 | 2.4 | 0.85 | 1.40 |
| 100% | 0.0% | 0.0% | 0.0% | 13.3 | 2.2 | 12.7 | 1.9 | 1.00 | 1.00 |
| 50% | 0.0% | 0.0% | 50.0% | 10.8 | 2.0 | 14.0 | 1.2 | 0.81 | 1.10 |
| 50% | 0.0% | 50.0% | 0.0% | 7.2 | 0.1 | 8.1 | 0.9 | 0.54 | 0.64 |
| 50% | 50.0% | 0.0% | 0.0% | 4.2 | 0.6 | 3.8 | 0.2 | 0.32 | 0.30 |

As shown in Table 2, multiple Binder Compositions including Portland Cement and the binder had a higher UCS than Portland Cement combined with just one of (i) quicklime, (ii) limestone, or (iii) pozzolan. That is, the improvement in UCS of the blends of the present technology disclosed herein are due in part to a combined effect of each of quicklime, limestone, pozzolan, and the admixture. For example, without being bound by theory, (i) the quicklime can provide calcium and/or calcium hydroxide particles and an alkali environment for silicate and aluminate found in the pozzolan to complete cement reactions that form calcium silicate hydrates and/or aluminum silicate hydrates that increase strength of the blend, (ii) the limestone can provide nucleation sites to catalyze such cement reactions, thereby enabling the reactions to initiate faster and/or better, and (iii) the pozzolan acts as a source of silicate and aluminate and reacts with the quicklime and/or calcium to enable strength-building pozzolanic reactions. Additionally or alternatively, by utilizing the admixtures, the UCS of the blends of the present technology, relative to that of Portland cement alone, will be greater (e.g., at Day 3, Day 7, Day 28, etc.) (as discussed further herein), while also providing a decrease (e.g., at least 30%, 40%, or 50% less) in carbon dioxide equivalent during production. Additionally or alternatively, the improvement in UCS for embodiments of the present technology may be due to the fines filler effect, which suggests that a specific particle size (e.g., fine limestone particles) or particle size distribution of the composition optimizes strength achieved when combined to make the mine backfill product. As disclosed herein, omitting one of the quicklime, calcium carbonate, or pozzolan will result in a composition with a lower UCS over time. Each composition including cement, quicklime, limestone, and pozzolan will provide some amount of strength, but there will be some ideal blend that optimizes these beneficiation mechanisms, e.g., from the limestone fines versus adding more reactants for the cement reactions.

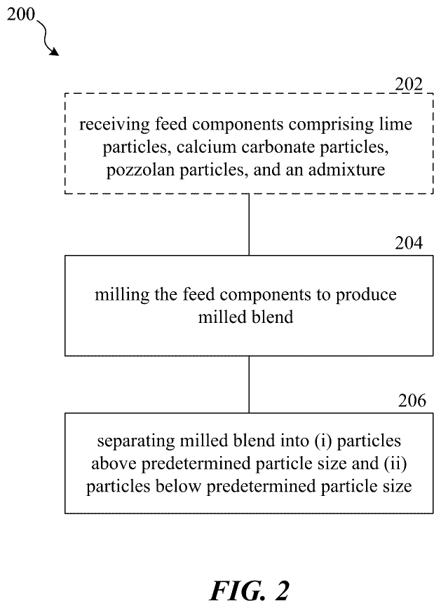

FIG. 2 is a flow diagram of a method 200 for producing lime-based cement extender compositions, in accordance with embodiments of the present technology. The method 200 includes receiving feed components comprising lime particles (e.g., the lime source 105; FIG. 1), calcium carbonate particles (e.g., the calcium carbonate source 110; FIG. 1), pozzolan particles (e.g., the pozzolan source 115; FIG. 1), and an admixture (e.g., the admixture source 140; FIG. 1) (process portion 202). Each of the lime particles, calcium carbonate particles, pozzolan particles, and admixture can originate from respective lime, calcium carbonate, pozzolan, and admixture sources and be weighed and conveyed via conveyor belts.

The method 200 further comprises milling the feed components (process portion 204). Milling the feed components can be done in a horizontal ball mill and can produce a milled product comprising (i) at least 10% by weight of the lime particles, (ii) 20%, 25%, 30%, 35%, 40%, 45%, 50%, or 25-50% by weight calcium carbonate particles, and (iii) 35%, 40%, 45%, 50%, 60%, 65%, 70% or 35-70% by weight pozzolan particles, and no more than 10%, 8%, 6%, 4%, or 2% by weight of the admixture. Additionally or alternatively, the milled blend can comprise a calcium oxide concentration of 45-65%, a magnesium oxide concentration of 0.5-2%, an iron oxide concentration of 0.5-2.0%, an aluminum oxide concentration of 2-8%, a silicon dioxide concentration of 20-40%, a potassium oxide concentration of 20,000-30,000 ppm, and a sodium oxide concentration of 10,000-20,000 ppm, e.g., as determined by elemental analysis from ICP methods, and an admixture. The admixture can be configured to promote reactions between the calcium oxide and the aluminum oxide and/or silicon dioxide. The blend can further include at least 20%, 25%, 30%, 35%, 40%, or 45% or cement blend. Milling (e.g., grinding) the feed components can also simultaneously blend the individual feed components to form a uniform blend, as well as dry the feed components to reduce their residual moisture content. Without being bound by theory, the heat for drying the feed components may originate from the heat of friction from the mechanical grinding action of the ball mill. Additionally or alternatively, the moisture content can also be reduced via the interaction of quicklime of the lime particles and residual moisture present within the ball mill, which react with one another (via Reaction 1) to form calcium hydroxide and heat.

The method 200 further includes separating oversized particles from the milled blend to produce a binder (e.g., the binder or lime-based cement extender composition referred to elsewhere herein), such that at least 90%, 95%, 97%, or 99% of the particles of the binder pass 200 mesh (process portion 206). Stated differently, at least 90% of the particles of the binder have a particle size no greater than 75 microns. Separation of the oversized particles can occur via an air classifier (e.g., the classifier 125), in which oversized particles are directed back to the mill (e.g., via a chute or return line) for further grinding and size reduction, and the remaining particles are directed to an outlet of the classifier. Structures other than air classifiers, such as screen decks, can also be used to separate oversized particles. The oversized particles directed back to the mill are eventually returned to the classifier (e.g., via a plurality of conveyors and bucket loaders). The remaining particles (e.g., the particles passing 200 mesh) can be directed to a dust collector, and subsequently to storage (e.g., product silos) as a product for distribution to customers.

In some embodiments, the binder can be combined with cement, water, and/or aggregates, e.g., to be used in the mining industry as a mine backfill. Doing so can effectively extend the use of cement, by maintaining or enhancing its utility while improving the economics associated with its use. The binder can comprise 40%, 45%, 50%, or 55% of the blend, with cement comprising the balance. The cement blend can have a UCS that increases over time, e.g., from Days 7 to 28 after formulation. For example, the UCS of the binder seven days after being formed is at least 8 MPa, 9 MPa, 10 MPa, 11 MPa, 12 MPa, or 13 MPa, and the unconfined compressive strength of the binder 28 days after being formed is at least 11 MPa, 12 MPa, 13 MPa, 14 MPa, 15 MPa, 16 MPa, or 17 MPa. Additionally or alternatively, the cement blend can, over time, have a higher UCS relative to cement alone. For example, the UCS of a cement blend comprising about 50% by weight of each of Portland Cement and binder (i.e., quicklime, calcium carbonate, pozzolan, and an admixture), at Day 28, can be higher than that of Portland Cement on its own. Additionally, the UCS of a cement blend comprising about 50% by weight of each of Portland Cement and binder (i.e., lime, calcium carbonate, pozzolan, and an admixture), at Day 28, can be higher than the UCS of Portland Cement and one of (i) lime, (ii) calcium carbonate, or (iii) pozzolan.

Embodiments of the present technology enable the production of products (e.g., mine backfill) by producing a lime-based cement extender composition that can effectively act as a substitute or alternative for fly ash when combined with cement. As such, embodiments of the present technology enable the production of improved compositions for mine backfill applications that do not include or rely on fly ash, and, additionally, are not affected by the diminishing supply and increased price of fly ash. Additionally, the lime-based cement extender compositions of the present technology can form an improved product that uses relatively less material, lasts longer, and has a higher unconfined compressive strength, relative to mine backfill products that include fly ash.

By including admixtures, compositions in accordance with embodiments of the present technology enable the formation of calcium aluminum sulfates (CAS) within (e.g., no more than) a predetermined period of time since blending with cement to form a cement blend. CAS can include ettringite and/or calcium aluminate monosulfate hydrate. The predetermined period of time can be 28 days, 21 days, 14 days, 7 days, etc. Forming CAS within a predetermined period of time (e.g., before the cement blend sets) can enable the necessary strength development of the cement blend. Alternatively, if the formation of CAS occurs over a longer period of time (e.g., more than a month or multiple months), the concrete will expand prior to formation of CAS which can thereby inhibit strength development or cause a decay in the developed strength. The presence or quantity of CAS in a cement blend or other cementitious material can be detected or measured, respectively, using quantitative X-ray diffraction (QXRD) and/or other known techniques in the art.

Additionally, producing embodiments of the present technology can result in fewer greenhouse gas emissions and a smaller carbon footprint relative to that of cement and fly ash, which is produced as a by-product of coal facilities. For example, certain admixtures (e.g., super plasticizers) allow less water to be used in the cement blend, thereby requiring less binder to be used, which in turn can equate to reduced greenhouse gas emissions and/or carbon footprint. Notably, using less water can also provide a functional benefit of enabling greater strength gain of the resulting cement blend.

### III. Experimental Results

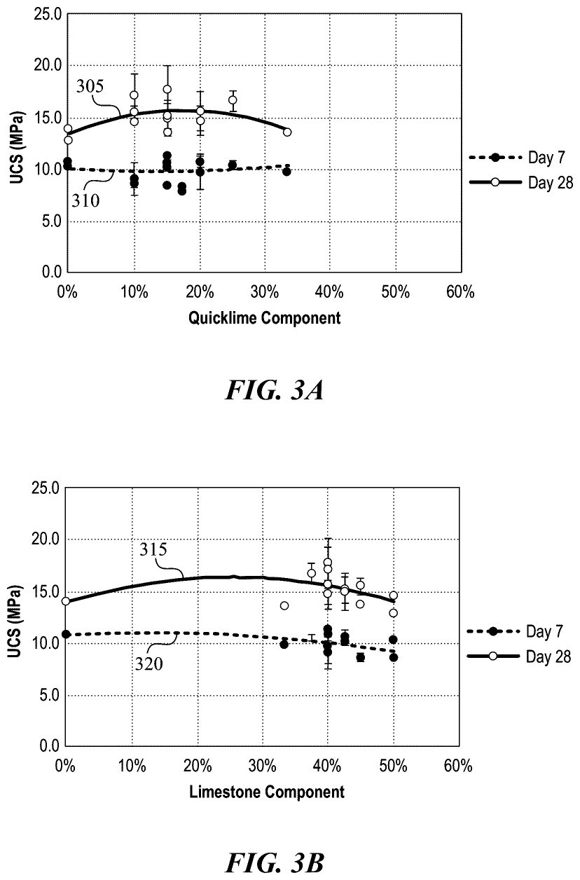

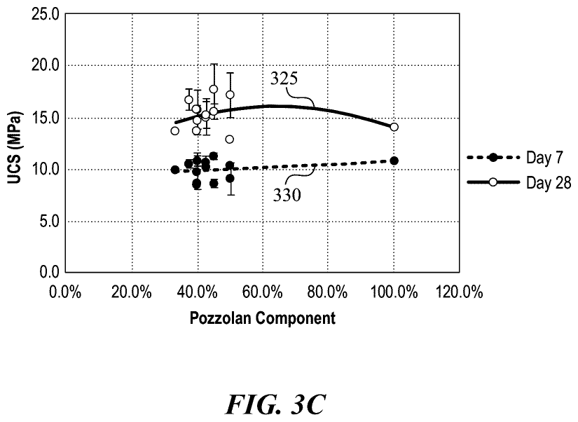

FIGS. 3A-3C are plots illustrating the relationship between UCS (MPa) and varying amounts of individual components of a composition, in accordance with embodiments of the present technology. FIG. 3A illustrates the relationship between UCS and varying amounts of quicklime, FIG. 3B illustrates the relationship between UCS and varying amounts of limestone, and FIG. 3C illustrates the relationship between UCS and varying amounts of pozzolan. The composition used for each of the plots of FIGS. 3A-3C includes 50% cement and varying amounts of the individual components as shown in FIGS. 3A-3C. As such, the percentages shown for each of the individual components in FIGS. 3A-3C represent 50% of the composition. Moreover, for each of the plots, which show varying amounts of one of the quicklime, limestone, or pozzolan, the amount of the other components also varies. For example, for the plot of FIG. 3A, which shows the amount of quicklime varying from 0% to about 34%, the amount of limestone and/or pozzolan also varies as the amount of quicklime increases. With reference to FIGS. 3A-3C together, the UCS exhibits a peak at various amounts for each of the individual components. For example, the UCS peak for quicklime occurs at about 17% (FIG. 3A), the UCS peak for limestone occurs at about 25% (FIG. 3B), and the UCS peak for pozzolan occurs at about 65% (FIG. 3C). As such, in some embodiments an optimal strength for the overall composition can occur when the composition comprises about 45-55% cement, about 6-10% quicklime, about 10-15% limestone, and about 30-35% pozzolan.

Table 3 includes data corresponding to the amount of available CaO and pH for a type I/II cement (“Cement”), a lime-based cement extender or binder (“Binder”), and a 1:1 mixture of the Cement and Binder. The Product here can correspond to the product or lime-based cement extender composition described above with reference to FIGS. 1 and/or 2.

TABLE 3

| Material | % Available CaO | pH |
|---|---|---|
| Type I/II Cement (“Cement”) | 15.7 | 12.1 |
| Lime-Based Cement Extender (“Binder”) | 10.3 | 12.5 |
| 1:1 Mixture of Cement and Binder | 16.4 | 12.5 |

The percent available CaO shown in Table 3 was determined based on ASTM C 25-19: “Standard Test Methods for Chemical Analysis of Limestone, Quicklime, and Hydrated Lime.” The pH was obtained by creating an about 5% slurry of the material in distilled water and measuring the pH once the temperature stabilized at room temperature (about 22° C.) using a calibrated pH electrode.

As shown in Table 3, the lime supplies at least 10% available lime in the Binder, which results in no reduction of available CaO in the blended mixtures. That is, the available lime of the Cement is about 15.7% and the available lime of the 1:1 mixture is about 16.4. Additionally, the lime maintains the pH above about 12.0, thereby enabling pozzolanic reactions to occur and/or continue, which develops UCS gains over time.

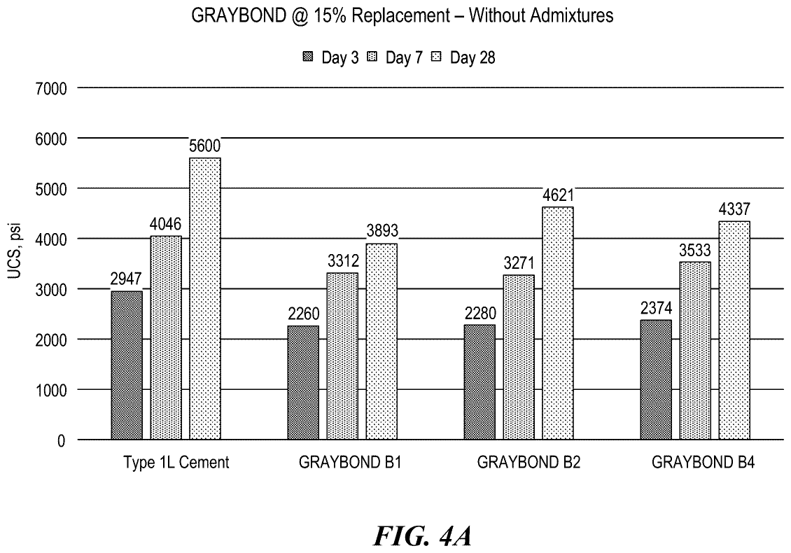

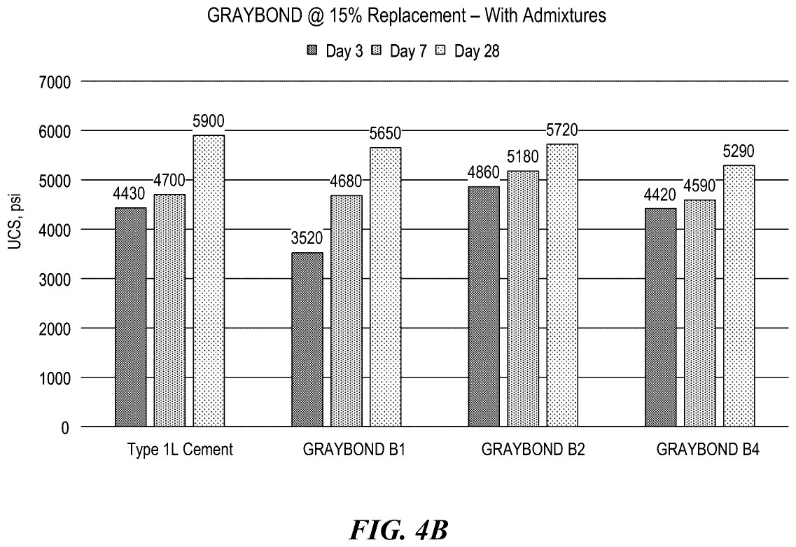

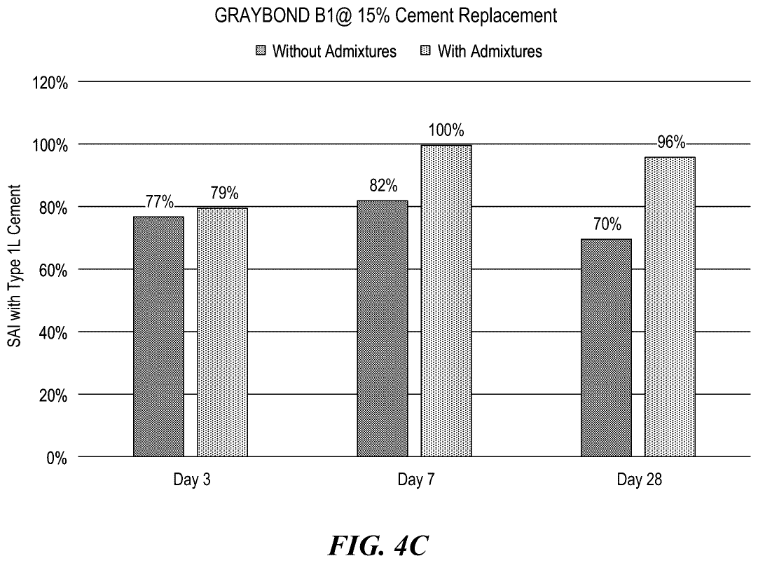

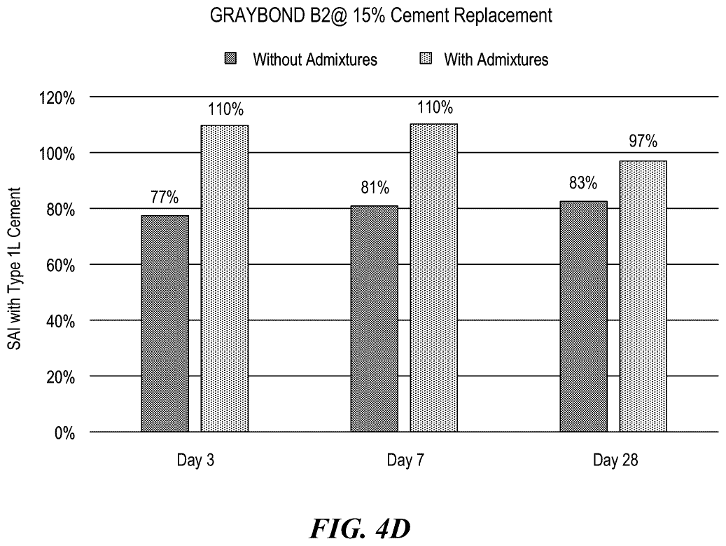

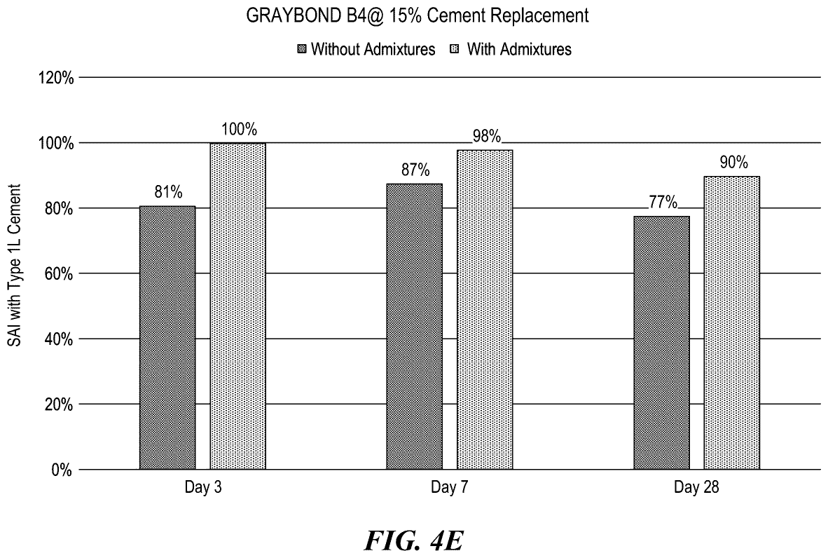

FIG. 4A illustrates the UCS of various concrete cylinders without admixtures over time (at day 3, at day 7, and at day 28 of curing), in accordance with embodiments of the present technology. The concrete cylinders used had an aspect (height-to-diameter) ratio of 2:1. More specifically, the vertical axis represents UCS (measured in psi) and the horizontal axis lists four concrete cylinders with different binders comprising (i) only Type 1L cement, (ii) a first blend of Type 1L cement with 15% substitution of a first binder, (iii) a second blend of Type 1L cement with 15% substitution of a second binder, and (iv) a third blend of Type 1L cement with 15% substitution of a third binder. The first binder comprises about 10% quicklime, 85% pozzolans, and 5% pulverized limestone, by weight. The second binder comprises about 10% hydrated lime, 85% pozzolans, and 5% pulverized limestone, by weight. The third binder comprises about 35% quicklime, 55% pozzolans, and 10% pulverized limestone, by weight.

FIG. 4B illustrates the UCS (measured in psi) of various concrete cylinders with admixtures over time (at day 3, at day 7, and at day 28 of curing), in accordance with embodiments of the present technology. The concrete cylinders had an aspect (height-to-diameter) ratio of 2:1. More specifically, the vertical axis represents UCS (measured in psi) and the horizontal axis lists the same four concrete cylinders with different binders (i)-(iv) as FIG. 4A, but with each concrete cylinder additionally including an admixture at less than 1% of the total binder content by weight. The admixture comprises a combination of a mid-range water reducer, a high-range water reducer, and an air entraining agent. Therefore, FIGS. 4A and 4B provide comparisons between various concrete cylinders without and with admixtures.

Comparing the UCS of concrete cylinders without admixtures (FIG. 4A) and the UCS of concrete cylinders with admixtures (FIG. 4B), the presence of admixtures provides increases in UCS for all four concrete cylinders with different binders, and at all times measured (at day 3, at day 7, and at day 28). Comparing the concrete cylinders comprising binder (i) of only Type 1L cement between FIGS. 4A and 4B, the presence of admixtures provides the most significant increase in UCS at day 3, from 2947 psi to 4430 psi (an approximately 50% increase). At day 7 and at day 28, the presence of admixtures provides more moderate increases in UCS, from 4046 psi to 4700 psi (an approximately 16% increase) and from 5600 psi to 5900 psi (an approximately 5% increase).

Comparing the concrete cylinders comprising binders (ii), (iii), and (iv) (e.g., with the first, second, and third binders, respectively) between FIGS. 4A and 4B, the presence of admixtures provides more consistent (relative to the concrete cylinder comprising binder (i)) increases in UCS over time. The percent increases in UCS are also comparable, with binder (ii) providing an increase in UCS at day 28 from 3893 psi to 5650 psi (an approximately 45% increase), binder (iii) providing an increase in UCS at day 28 from 4621 psi to 5720 psi (an approximately 24% increase), and binder (iv) providing an increase in UCS at day 28 from 4337 psi to 5290 psi (an approximately 22% increase). Therefore, FIGS. 4A and 4B illustrate that binder compositions including admixtures in accordance with embodiments of the present technology provide consistent and significant improvements in UCS relative to binders without admixtures.

FIG. 4C illustrates the Strength Activity Index (SAI) of the concrete cylinder with binder (ii) (the first blend of Type 1L cement with 15% substitution of the first binder) over time, in accordance with embodiments of the present technology. FIG. 4D illustrates the SAI of the concrete cylinder with binder (iii) (the second blend of Type 1L cement with 15% substitution of the second binder) over time, in accordance with embodiments of the present technology. FIG. 4E illustrates the Strength Activity Index (SAI) of the concrete cylinder with binder (iv) (the third blend of Type 1L cement with 15% substitution of the third binder) over time, in accordance with embodiments of the present technology. Referring to FIGS. 4C-4E together, the vertical axis represents the SAI, which is a comparative measure of the USC of the concrete cylinder with binders (ii)-(iv) against the concrete cylinder with binder (i) (only Type 1L cement). More specifically, the SAI is calculated as: UCS of concrete cylinder with binder of interest

$$SAI = \frac{UCS of concrete cylinder with binder of interest}{UCS of concrete cylinder with binder of only Type 1 L cement} \times 100 \%$$

In some embodiments, a certain SAI value or a minimum SAI value is achieved over time due to the formation of calcium aluminum sulfates over time, such as ettringite. The horizontal axis lists different times (at day 3, at day 7, and at day 28 of curing), and for each time, provides the concrete cylinder with the binder of interest without admixtures and with admixtures.

In many applications and under notable industry standards, achieving a minimum SAI of 75% is required (e.g., at least 75% at day 7 and at day 28 under ASTM C618). In practice, achieving a minimum SAI of 95% can be highly desired, as a higher SAI indicates near-equivalent (or even better) performance than concrete cylinders with the binder of only Type 1L element (or other baseline). As discussed below, cement blends including compositions in accordance with embodiments of the present technology can have a SAI of at least 80%, 85%, 90%, 95%, 100%, or 110% or within a range of 80-110% within 7 days, within 28 days, etc.

Referring to FIGS. 4C-4E together and focusing on the SAI of concrete cylinders without admixtures, the SAI ranges between 77-81% at day 3, ranges between 81-87% at day 7, and ranges between 70-83% at day 28. Of note, the concrete cylinders with binders (iii) and (iv) would comply with, e.g., the ASTM C618 SAI requirements, but the concrete cylinder with binder (ii) would not comply therewith. Next, referring to FIGS. 4C-4E together and focusing on the SAI of concrete cylinders with admixtures, the SAI ranges between 79-110% at day 3, ranges between 98-110% at day 7, and ranges between 90-97% at day 28. Of note, unlike in the case in which no admixtures are present, all three concrete cylinders with binders (ii), (iii), and (iv) with admixtures would comply with, e.g., the ASTM C618 SAI requirements. The concrete cylinder with binder (iii) and admixtures is particularly noteworthy, as its UCS remains above 95% at day 3, at day 7, and at day 28.

Therefore, FIGS. 4C-4E show that the addition of admixtures to the binder composition can increase UCS (and consequently the SAI) and potentially bring a material into compliance with certain SAI requirements that the material would otherwise not be in compliance with. It is appreciated that the admixtures used for the collection of the experimental data presented in FIGS. 4A-4E were optimized for the cement component and not the binder composition. Therefore, it is expected that further refinement and optimization of admixtures can provide additional improvements to the performance of binder compositions in accordance with embodiments of the present technology.

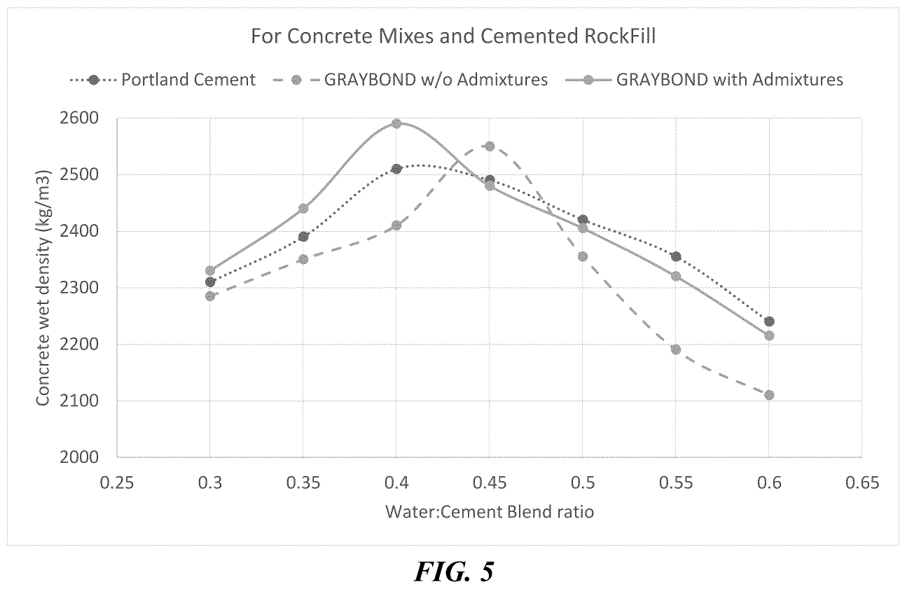

FIG. 5 illustrates how concrete wet densities of various types of cement blend pastes (cement mixed with binders and/or water) vary with different water-to-cement blend ratios (by weight), in accordance with embodiments of the present technology. More specifically, the vertical axis represents concrete wet density (measured in kg/m³) (e.g., as measured right after mixing the cement blend with water), and the horizontal axis represents water-to-cement blend ratio. The graph of FIG. 5 plots cement blend pastes including (i) Portland cement (dotted line), (ii) a cement blend including Portland cement and binders without admixtures (dashed line), and (iii) a cement blend including Portland cement and binders with admixtures (solid line).

Varying the amount of water added to pure cement or cement blends (cement combined with binders) in accordance with embodiments of the technology can change the water-to-cement blend ratio, and as shown in FIG. 5, different water-to-cement blend ratios can result in different concrete wet densities. For example, in the illustrated graph, (i) the concrete wet density of the cement blend paste with Portland cement peaks at around 2510 kg/m³ when the water-to-cement blend ratio is about 0.41, (ii) the concrete wet density of the cement blend paste including Portland cement and binders without admixtures peaks at around 2550 kg/m³ when the water-to-cement blend ratio is about 0.45, and (iii) the concrete wet density of the cement blend paste including Portland cement and binders with admixtures peaks at around 2590 kg/m³ when the water-to-cement blend ratio is about 0.4.

As shown, the cement blend paste including Portland cement and binders with admixtures in accordance with embodiments of the present technology can achieve a higher maximum concrete wet density than the cement blend paste including Portland cement alone or the cement blend paste without admixtures, and can do so at a smaller water-to-cement blend ratio. The concrete wet density can positively correlate with strength (e.g., UCS, SAI), so the cement blend with admixtures can have higher strength than the other two cementitious materials mixed with water. Also, the amount of water added can be based on a balancing between strength (less water added) and flowability or workability (more water added). Therefore, by achieving its maximum concrete wet density at a lower water-to-cement blend ratio, the cement blend paste including admixtures can achieve greater strength.

Also, the graph of FIG. 5 illustrates the principle that the amount of water added to cement or cement blends (when forming cement blend pastes) can be controlled to achieve, e.g., a peak concrete wet density and thereby a peak concrete strength. Therefore, a lime-based concrete blend paste can include a cement blend and water, where the quantity of the water is determined based on a water-to-cement blend weight ratio configured to maximize a concrete wet density of the lime-based cement blend paste. In some embodiments, the water-to-cement blend weight ratio configured to maximize the concrete wet density of the lime-based cement blend paste is between 0.35-0.45, 0.37-0.43, or about 0.4.

### IV. CONCLUSION

It will be apparent to those having skill in the art that changes can be made to the details of the above-described embodiments without departing from the underlying principles of the present technology. In some cases, well known structures and functions have not been shown or described in detail to avoid unnecessarily obscuring the description of the embodiments of the present technology. Although steps of methods can be presented herein in a particular order, alternative embodiments can perform the steps in a different order. Similarly, certain aspects of the present technology disclosed in the context of particular embodiments can be combined or eliminated in other embodiments. Furthermore, while advantages associated with certain embodiments of the present technology can have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Where context permits, singular or plural terms can also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/of” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” can be based on both condition A and condition B without departing from the scope of the present disclosure. In other words, as used herein, the phrase “based on” shall be construed in the same manner as the phrase “based at least in part on” or the phrase “based at least partially on.”

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics can be combined in any suitable manner in one or more embodiments.

Unless otherwise indicated, all numbers expressing concentrations, shear strength, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below as numbered clauses (1, 2, 3, etc.) for convenience. These are provided as examples and do not limit the present technology. It is noted that any of the dependent clauses can be combined in any combination, and placed into a respective independent clause. The other clauses can be presented in a similar manner.

1. A lime-based composition, comprising:
lime particles comprising calcium hydroxide and/or calcium oxide;
pozzolan particles comprising silicon dioxide and/or aluminum dioxide, wherein at least 90% of the lime particles and pozzolan particles are less than 75 microns; and
an admixture,
wherein, when the composition is mixed with cement to form a cement blend, calcium aluminum sulfate forms within 28 days.

2. The composition of any one of the clauses herein, wherein the cement blend has a Strength Activity Index (SAI) of at least 80% within 7 days.

3. The composition of any one of the clauses herein, wherein the cement blend has a Strength Activity Index (SAI) of at least 90% within 28 days.

4. The composition of any one of the clauses herein, wherein the calcium aluminum sulfate comprises at least one of ettringite or calcium aluminate monosulfate hydrate.

5. The composition of any one of the clauses herein, wherein, when the composition is mixed with cement to form the cement blend, the calcium aluminum sulfate forms within 14 days.

6. The composition of any one of the clauses herein, wherein the admixture comprises a mid-range water reducer and lignosulphonates.

7. The composition of any one of the clauses herein, wherein the admixture comprises an accelerant including at least one of chloride, calcium chloride, sodium thiocyanate, calcium formate, calcium nitrate, or calcium nitrite.

8. The composition of any one of the clauses herein, wherein the admixture comprises a retardant including at least one of calcium salts, magnesium salts, sodium salts, ammonium salts, oxides of lead and zinc, phosphates, fluorates, borates, or carbohydrates.

9. The composition of any one of the clauses herein, wherein the admixture comprises an air entrainer including at least one of fatty acid salts, abietic and pimelic acid salts, alkyl acryl sulphonates, alkyl sulphonates, phenol ethoxylates, rosin resins, aliphatic alcohol sulfonates, protein salts, or petroleum sulfonates.

10. The composition of any one of the clauses herein, wherein the admixture comprises less than 1% by weight of the composition.

11. The composition of any one of the clauses herein, wherein the admixture comprises two or more of an accelerant, a retardant, a water reducer, or an air entrainer.

12. The composition of any one of the clauses herein, further comprising calcium carbonate particles.

13. The composition of clause 12, wherein:
the lime particles comprise 10-35% by weight of the composition,
the calcium carbonate particles comprise 5-10% by weight of the composition, and
the pozzolan particles comprise 55-85% by weight of the composition.

14. A lime-based composition, comprising:
lime particles comprising calcium hydroxide and/or calcium oxide;
pozzolan particles comprising silicon dioxide and/or aluminum dioxide, wherein at least 90% of the lime particles and pozzolan particles are less than 75 microns; and
an admixture,
wherein, when the composition is mixed with cement to form a cement blend, the cement blend has a Strength Activity Index (SAI) of at least 90% within 28 days of mixing.

15. The composition of any one of the clauses herein, wherein the cement blend has a Strength Activity Index (SAI) of at least 95% within 7 days of mixing.

16. The composition of any one of the clauses herein, wherein, when the composition is mixed with cement to form the cement blend, ettringite forms within 28 days.

17. The composition of any one of the clauses herein, wherein, when the composition is mixed with cement to form the cement blend, calcium aluminate monosulfate hydrate forms within 28 days.

18. The composition of any one of the clauses herein, wherein the admixture comprises a high-range water reducer configured to achieve at least 12% in water reduction and at least 8 inches of slump increase, and wherein the admixture comprises at least one of polycarboxylates, sulfonated melamines, vinyl copolymers, or lignosulphonates.

19. The composition of any one of the clauses herein, wherein the admixture comprises an accelerant including at least one of chloride, calcium chloride, sodium thiocyanate, calcium formate, calcium nitrate, or calcium nitrite.

20. The composition of any one of the clauses herein, wherein the admixture comprises a retardant including at least one of calcium salts, magnesium salts, sodium salts, ammonium salts, oxides of lead and zinc, phosphates, fluorates, borates, or carbohydrates.

21. The composition of any one of the clauses herein, wherein the admixture comprises less than 10% by weight of the composition.

22. The composition of any one of the clauses herein, wherein, when the composition is mixed with the cement to form the cement blend, calcium aluminum sulfate forms within a predetermined amount of time.

23. The composition of any one of the clauses herein, wherein, when the composition is mixed with the cement to form the cement blend, calcium aluminum sulfate forms within 28 days.

24. A method of forming a cement blend, the method comprising:
blending (i) lime particles comprising calcium hydroxide and/or calcium oxide, (ii) pozzolan particles comprising silicon dioxide and/or aluminum dioxide, (iii) an admixture, and (iv) cement; and
forming calcium aluminum sulfate within a predetermined amount of time since blending.

25. The method of any one of the clauses herein, wherein the predetermined amount of time is 28 days.

26. The method of any one of the clauses herein, wherein the predetermined amount of time is 14 days.

27. The method of any one of the clauses herein, wherein the cement blend has a Strength Activity Index (SAI) of at least 90% within 7 days of blending.

28. The method of any one of the clauses herein, wherein the cement blend has a Strength Activity Index (SAI) of at least 95% within 28 days of blending.

29. The method of any one of the clauses herein, wherein the admixture comprises two or more of an accelerant, a retardant, a water reducer, or an air entrainer.

30. The method of any one of the clauses herein, further comprising blending the lime particles, the pozzolan particles, the admixture, and the cement with calcium carbonate particles.

31. A lime-based cement blend paste, comprising:
a cement blend comprising cement and a lime-based cement extender composition, wherein the lime-based cement extender composition comprises:
   a calcium oxide concentration of 45-65%;
   a magnesium oxide concentration of 0.5-2%;
   an iron oxide concentration of 0.5-2%;
   an aluminum oxide concentration of 2-8%;
   a silicon dioxide concentration of 20-40%;
   a potassium oxide concentration of 20,000-30,000 ppm;
   a sodium oxide concentration of 10,000-20,000 ppm; and
   an admixture configured to promote reactions between the calcium oxide and at least one of the aluminum oxide or silicon dioxide; and
water, wherein a quantity of the water is determined based on a water-to-cement blend weight ratio configured to maximize a concrete wet density of the lime-based cement blend paste.

32. The lime-based cement blend paste of any one of the clauses herein, wherein the water-to-cement blend weight ratio configured to maximize the concrete wet density of the lime-based cement blend paste is between 0.37-0.43.

33. A lime-based binder or cement extender composition, comprising:
lime particles comprising calcium hydroxide and/or calcium oxide;
calcium carbonate particles;
pozzolan particles comprising silicon dioxide and/or aluminum dioxide; and
an admixture configured to promote reactions between the lime particles and the pozzolan particles,
wherein at least 90% of the lime particles, calcium carbonate particles, and pozzolan particles are less than 75 microns.

34. The composition of any one of the clauses herein, wherein the admixture comprises at least one of an accelerant, a water reducer, and/or an activator.

35. The composition of any one of the clauses herein, wherein the admixture comprises at least one of an accelerant, a retardant, a water reducer, an air entrainer, or an activator.

36. The composition of any one of the clauses herein, wherein the admixture comprises a water reducer including a superplasticizer and/or synthetic polymer.

37. The composition of any one of the clauses herein, wherein the admixture comprises a low-range water reducer configured to achieve 5-10% in water reduction and 1-2 inches of slump increase, and wherein the admixture comprises at least one of lignosulphonates, carbohydrates, or hydrocarboxylic acids.

38. The composition of any one of the clauses herein, wherein the admixture comprises a mid-range water reducer configured to achieve 8-18% in water reduction and 4-5 inches of slump increase, and wherein the admixture comprises lignosulphonates.

39. The composition of any one of the clauses herein, wherein the admixture comprises a high-range water reducer configured to achieve at least 12% in water reduction and at least 8 inches of slump increase, and wherein the admixture comprises at least one of polycarboxylates, sulfonated melamines, vinyl copolymers, or lignosulphonates.

40. The composition of any one of the clauses herein, wherein the admixture comprises an accelerant including at least one of a chloride, calcium chloride, sodium thiocyanate, calcium formate, calcium nitrate, or calcium nitrite.

41. The composition of any one of the clauses herein, wherein the accelerant comprises at least one of calcium chloride, sodium thiocyanate, calcium formate, calcium nitrate, and/or calcium nitrite.

42. The composition of any one of the clauses herein, wherein the admixture comprises a retardant including at least one of calcium salts, magnesium salts, sodium salts, ammonium salts, oxides of lead and zinc, phosphates, fluorates, borates, or carbohydrates.

43. The composition of any one of the clauses herein, wherein the composition comprises no more than 10%, 8%, 6%, 4%, 2%, or 1% of the admixture by weight.

44. The composition of any one of the clauses herein, wherein the admixture comprises a slurry.

45. The composition of any one of the clauses herein, wherein:
the lime particles comprise at least 10% by weight of the composition, the calcium carbonate particles comprise at least 20% by weight of the composition, and the pozzolan particles comprise at least 35% by weight of the composition.

46. The composition of any one of the clauses herein, wherein:
the lime particles comprise 10-20% by weight of the composition,
the calcium carbonate particles comprise 40-50% by weight of the composition, and
the pozzolan particles comprise 35-50% by weight of the composition.

47. The composition of any one of the clauses herein, wherein:
the lime particles comprise 10-35% by weight of the composition,
the calcium carbonate particles comprise 5-10% by weight of the composition, and
the pozzolan particles comprise 55-85% by weight of the composition.

48. The composition of any one of the clauses herein, wherein the composition comprises:
a calcium oxide concentration of 45-65%;
a magnesium oxide concentration of 0.5-2%;
an iron oxide concentration of 0.5-2%
an aluminum oxide concentration of 2-8%;
a silicon dioxide concentration of 20-40%;
a potassium oxide concentration of 20,000-30,000 ppm; and
a sodium oxide concentration of 10,000-20,000 ppm.

49. The composition of any one of the clauses herein, wherein the lime particles comprise a calcium concentration of at least 85%, 90%, 91%, 92%, 93%, 94%, or 95% by weight.

50. The composition of any one of the clauses herein, wherein the lime particles comprise at least one of quicklime, hydrated lime, or dolomitic lime.

51. The composition of any one of the clauses herein, wherein the calcium carbonate particles comprise (i) high-calcium limestone, precipitated calcium carbonate, argillaceous limestone or dolomitic lime and (ii) a calcium concentration of at least 85%, 90%, 91%, 92%, 93%, 94% or 95% by weight.

52. The composition of any one of the clauses herein, wherein the pozzolan particles comprise (i) at least 50,000 ppm potassium oxide, and (ii) at least 30,000 ppm sodium oxide.

53. The composition of any one of the clauses herein, wherein the pozzolan particles comprise volcanic ash or zeolite.

54. The composition of any one of the clauses herein, wherein the pozzolan particles comprise at least one of calcined clay, silicate, aluminate, silica flume, or pozzolan slag.

55. The composition of any one of the clauses herein, wherein at least 99% of the lime particles, calcium carbonate particles, and pozzolan particles are less than 75 microns.

56. The composition of any one of the clauses herein, wherein the composition does not include fly ash.

57. A cement blend for use in the mining and/or construction industry, comprising: cement; and
a lime-based cement extender composition comprising:
   a calcium oxide concentration of 45-65%;
   a magnesium oxide concentration of 0.5-2%;
   an iron oxide concentration of 0.5-2%;
   an aluminum oxide concentration of 2-8%;
   a silicon dioxide concentration of 20-40%;
   a potassium oxide concentration of 20,000-30,000 ppm;
   a sodium oxide concentration of 10,000-20,000 ppm; and
   an admixture configured to promote reactions between the calcium oxide and at least one of the aluminum oxide or silicon dioxide,
wherein the lime-based cement extender composition comprises at least 25% of the cement blend.

58. The cement blend of any one of the clauses herein, wherein the lime-based cement extender is the lime-based cement extender of any one of the previous clauses.

59. The cement blend of any one of the clauses herein, wherein the admixture comprises a water reducer comprising 0.2-0.8% by weight of the cement blend.

60. The cement blend of any one of the clauses herein, wherein the cement blend complies with the ASTM C618 SAI requirements.

61. The cement blend of any one of the clauses herein, wherein the cement blend consists of the cement and the lime-based cement extender.

62. The cement blend of any one of the clauses herein, wherein the cement blend does not include fly ash.

63. The cement blend of any one of the clauses herein, wherein the cement comprises 45-55% of the cement blend.

64. The cement blend of any one of the clauses herein, wherein the lime-based cement extender composition comprises 10-33.4% of the calcium oxide, 33.4-50% of at least one of the aluminum oxide or silicon dioxide, and at least 1% admixture.

65. The cement blend of any one of the clauses herein, wherein the lime-based cement extender further comprises calcium carbonate, and wherein the lime-based cement extender composition comprises 10-33.4% of the calcium oxide, 33.4-50% of the calcium carbonate, 33.4-50% of at least one of the aluminum oxide or silicon dioxide, and at least 1% of the admixture.

66. The cement blend of any one of the clauses herein, wherein, after at least 28 days of being formed, the unconfined compressive strength of the cement blend is at least 11 MPa.

67. The cement blend of any one of the clauses herein, wherein, after at least seven days of being formed, the unconfined compressive strength of the cement blend is at least 8 MPa.

68. The cement blend of any one of the clauses herein, wherein:
the lime-based cement extender comprises calcium carbonate,
the admixture comprises an accelerant including at least one of calcium chloride, sodium thiocyanate, calcium formate, calcium nitrate, and/or calcium nitrite,
the calcium oxide comprises at least 10% by weight of the composition, and
the calcium carbonate comprises at least 20% by weight of the composition.

69. The cement blend of any one of the clauses herein, wherein at least 50% of the lime-based cement extender is less than 75 microns.

70. The cement blend of any one of the clauses herein, wherein the composition does not include fly ash.

71. A system for producing a lime-based cement extender composition, the system comprising:
a mill positioned to receive feed components including lime particles, calcium carbonate particles, pozzolan particles, and admixture particles, wherein the mill is configured to produce a milled blend by milling and blending the quicklime particles, the calcium carbonate particles, the pozzolan particles, and the admixture particles; and
a classifier downstream of the mill and positioned to receive the milled blend, wherein the classifier comprises an outlet, a return line extending toward the mill, and a separator sized such that particles above a predetermined particle size are directed to the return line and particles below a predetermined particle size are directed to the outlet.

72. The system of any one of the clauses herein, wherein the mill is a horizontal ball mill.

73. The system of any one of the clauses herein, wherein the mill is configured to reduce a moisture content of the feed components, such that the milled blend comprises a moisture content less than 5% by weight.

74. The system of any one of the clauses herein, further comprising:
a lime source including the quicklime particles;
a calcium carbonate source including the calcium carbonate particles;
a pozzolan source including the pozzolan particles;
an admixture source including the admixture particles; and
conveyors extending from each of the lime source, calcium carbonate source, the pozzolan source, and the admixture source to the mill.

75. The system of any one of the clauses herein, further comprising one or more screw conveyors and bucket elevators configured to direct the milled blend to the classifier.

76. The system of any one of the clauses herein, wherein the predetermined particle size is 75 microns, the system further comprising a dust collector downstream of the classifier and configured to receive the particles below the predetermined particle size.

77. The system of any one of the clauses herein, wherein the classifier is configured to produce a lime-based cement extender that is the lime-based cement extender of any one of the previous clauses herein.

78. The system of any one of the clauses herein, wherein the classifier is configured to produce a lime-based cement extender composition comprising:
a calcium oxide concentration of 45-65%;
a magnesium oxide concentration of 0.5-2%;
an iron oxide concentration of 0.5-2%;
an aluminum oxide concentration of 2-8%;
a silicon dioxide concentration of 20-40%;
a potassium oxide concentration of 20,000-30,000 ppm; and
a sodium oxide concentration of 10,000-20,000 ppm.

79. The system of any one of the clauses herein, wherein the milled blend comprises (i) at least 10% by weight of the lime particles, (ii) at least 30% by weight of the calcium carbonate particles, (iii) at least 30% by weight of the pozzolan particles, and (iv) at least 1% by weight of the admixture particles.

80. The system of any one of the clauses herein, wherein:
the lime particles comprise a calcium concentration of at least 85% by weight,
the calcium carbonate particles comprise at least one of high-calcium limestone, argillaceous limestone or dolomitic lime,
the pozzolan particles comprise at least one of volcanic ash, zeolite, calcined clay, silicate, aluminate, silica flume, or pozzolan slag, and
the admixture comprises an accelerant including at least one of calcium chloride, sodium thiocyanate, calcium formate, calcium nitrate, or calcium nitrite.

81. A method for producing a lime-based cement extender composition, the method comprising:
receiving, via a mill, feed components including quicklime particles, calcium carbonate particles, pozzolan particles, and admixture particles;
producing, via the mill, a milled blend by milling and blending the quicklime particles, the calcium carbonate particles, the pozzolan particles, and the admixture particles; and
conveying the milled blend from the mill to a classifier, wherein the classifier comprises an outlet, a return line extending toward the mill, and a separator sized such that particles at or above a predetermined particle size are directed to the return line and particles below a predetermined particle size are directed to the outlet.

82. The method of any one of the clauses herein, wherein the mill is a horizontal ball mill.

83. The method of any one of the clauses herein, further comprising reducing, via the mill, a moisture content of the feed components, such that the milled blend comprises a moisture content less than 5% by weight.

84. The method of any one of the clauses herein, wherein:
the lime particles are received from a lime source,
the calcium carbonate particles are received from a calcium carbonate source,
the pozzolan is received from a pozzolan source,
the admixture is received from an admixture source, and
conveying the lime particles, calcium carbonate particles, pozzolan particles, and admixture particles occurs via conveyors extending from each of the lime source, calcium carbonate source, the pozzolan source, and the admixture source to the mill.

85. The method of any one of the clauses herein, wherein conveying the lime particles, calcium carbonate particles, pozzolan particles, and admixture particles occurs via one or more screw conveyors and bucket elevators.

86. The method of any one of the clauses herein, wherein the predetermined particle size is at least 75 microns, the method further comprising, receiving, via a dust collector downstream of the classifier, the particles below the predetermined particle size.

87. The method of any one of the clauses herein, further comprising producing, via the classifier, a lime-based cement extender that is the lime-based cement extender of any one of the previous clauses herein.

88. The method of any one of the clauses herein, further comprising producing, via the classifier, a lime-based cement extender composition comprising:
a calcium oxide concentration of 45-65%;
a magnesium oxide concentration of 0.5-2%;
an iron oxide concentration of 0.5-2%;
an aluminum oxide concentration of 2-8%;
a silicon dioxide concentration of 20-40%;
a potassium oxide concentration of 20,000-30,000 ppm; and
a sodium oxide concentration of 10,000-20,000 ppm.

89. The method of any one of the clauses herein, wherein the milled blend comprises (i) at least 10% by weight of the lime particles, (ii) at least 30% by weight of the calcium carbonate particles, (iii) at least 30% by weight of the pozzolan particles, and (iv) no more than 6%, 4%, or 2% by weight of the admixture particles.

90. The method of any one of the clauses herein, wherein:
the lime particles comprise a calcium concentration of at least 85% by weight, and the calcium carbonate particles comprise at least one of high-calcium limestone, argillaceous limestone or dolomitic lime,
the pozzolan particles comprise at least one of volcanic ash, zeolite, calcined clay, silicate, aluminate, silica flume, or pozzolan slag, and
the admixture comprises an accelerant including at least one of calcium chloride, sodium thiocyanate, calcium formate, calcium nitrate, or calcium nitrite.

I/We claim:

1. A lime-based composition, comprising:
lime particles comprising calcium hydroxide and/or calcium oxide;
pozzolan particles comprising silicon dioxide and/or aluminum dioxide, wherein at least 90% of the lime particles and pozzolan particles are less than 75 microns; and
an admixture,
wherein, when the composition is mixed with cement to form a cement blend, calcium aluminum sulfate forms within 28 days.

2. The composition of claim 1, wherein the cement blend has a Strength Activity Index (SAI) of at least 80% within 7 days.

3. The composition of claim 2, wherein the cement blend has a Strength Activity Index (SAI) of at least 90% within 28 days.

4. The composition of claim 1, wherein the calcium aluminum sulfate comprises at least one of ettringite or calcium aluminate monosulfate hydrate.

5. The composition of claim 1, wherein, when the composition is mixed with cement to form the cement blend, the calcium aluminum sulfate forms within 14 days.

6. The composition of claim 1, wherein the admixture comprises a mid-range water reducer and lignosulphonates.

7. The composition of claim 1, wherein the admixture comprises an accelerant including at least one of chloride, calcium chloride, sodium thiocyanate, calcium formate, calcium nitrate, or calcium nitrite.

8. The composition of claim 1, wherein the admixture comprises a retardant including at least one of calcium salts, magnesium salts, sodium salts, ammonium salts, oxides of lead and zinc, phosphates, fluorates, borates, or carbohydrates.

9. The composition of claim 1, wherein the admixture comprises an air entrainer including at least one of fatty acid salts, abietic and pimelic acid salts, alkyl acryl sulphonates, alkyl sulphonates, phenol ethoxylates, rosin resins, aliphatic alcohol sulfonates, protein salts, or petroleum sulfonates.

10. The composition of claim 1, wherein the admixture comprises less than 1% by weight of the composition.

11. The composition of claim 1, wherein the admixture comprises two or more of an accelerant, a retardant, a water reducer, or an air entrainer.

12. The composition of claim 1, further comprising calcium carbonate particles.

13. The composition of claim 12, wherein:
the lime particles comprise 10-35% by weight of the composition,
the calcium carbonate particles comprise 5-10% by weight of the composition, and
the pozzolan particles comprise 55-85% by weight of the composition.

1. A lime-based composition, comprising:
lime particles comprising calcium hydroxide and/or calcium oxide;
pozzolan particles comprising silicon dioxide and/or aluminum dioxide, wherein at least 90% of the lime particles and pozzolan particles are less than 75 microns; and
an admixture,
wherein, when the composition is mixed with cement to form a cement blend, the cement blend has a Strength Activity Index (SAI) of at least 90% within 7 days of mixing.

2. The composition of claim 14, wherein the cement blend has a Strength Activity Index (SAI) of at least 95% within 28 days of mixing.

3. The composition of claim 14, wherein, when the composition is mixed with cement to form the cement blend, ettringite forms within 28 days.

4. The composition of claim 14, wherein, when the composition is mixed with cement to form the cement blend, calcium aluminate monosulfate hydrate forms within 28 days.

5. The composition of claim 14, wherein the admixture comprises a high-range water reducer configured to achieve at least 12% in water reduction and at least 8 inches of slump increase, and wherein the admixture comprises at least one of polycarboxylates, sulfonated melamines, vinyl copolymers, or ligno sulphonates.

6. The composition of claim 14, wherein the admixture comprises an accelerant including at least one of chloride, calcium chloride, sodium thiocyanate, calcium formate, calcium nitrate, or calcium nitrite.

7. The composition of claim 14, wherein the admixture comprises a retardant including at least one of calcium salts, magnesium salts, sodium salts, ammonium salts, oxides of lead and zinc, phosphates, fluorates, borates, or carbohydrates.

8. The composition of claim 14, wherein the admixture comprises less than 10% by weight of the composition.

9. The composition of claim 14, wherein, when the composition is mixed with the cement to form the cement blend, calcium aluminum sulfate forms within a predetermined amount of time.

10. The composition of claim 14, wherein, when the composition is mixed with the cement to form the cement blend, calcium aluminum sulfate forms within 28 days.

11. A method of forming a cement blend, the method comprising:
blending (i) lime particles comprising calcium hydroxide and/or calcium oxide, (ii) pozzolan particles comprising silicon dioxide and/or aluminum dioxide, (iii) an admixture, and (iv) cement; and
forming calcium aluminum sulfate within a predetermined amount of time since blending.

12. The method of claim 24, wherein the predetermined amount of time is 28 days.

13. The method of claim 24, wherein the cement blend has a Strength Activity Index (SAI) of at least 90% within 7 days of blending.

14. The method of claim 24, wherein the admixture comprises two or more of an accelerant, a retardant, a water reducer, or an air entrainer.

15. The method of claim 24, further comprising blending the lime particles, the pozzolan particles, the admixture, and the cement with calcium carbonate particles.

16. A lime-based cement blend paste, comprising:
a cement blend comprising cement and a lime-based cement extender composition, wherein
the lime-based cement extender composition comprises:
a calcium oxide concentration of 45-65%;
a magnesium oxide concentration of 0.5-2%;
an iron oxide concentration of 0.5-2%;
an aluminum oxide concentration of 2-8%;
a silicon dioxide concentration of 20-40%;
a potassium oxide concentration of 20,000-30,000 ppm;
a sodium oxide concentration of 10,000-20,000 ppm; and
an admixture configured to promote reactions between the calcium oxide and at least one of the aluminum oxide or silicon dioxide; and
water, wherein a quantity of the water is determined based on a water-to-cement blend weight ratio corresponding to a predetermined concrete wet density of the lime-based cement blend paste.

17. The lime-based cement blend paste of claim 29, wherein the water-to-cement blend weight ratio is between 0.37-0.43.
